(19) United States
(12) Patent Application Publication
(10) Pub. No.: US 2014/0050311 A1
(43) Pub. Date: Feb. 20, 2014

(54) TELEPHONE CALL SET CORRELATION AND INFORMATION RANKING

(71) Applicants: Kulvir S. Bhogal, Fort Worth, TX (US); Lisa Seacat DeLuca, San Francisco, CA (US); Robert R. Peterson, Austin, TX (US)

(72) Inventors: Kulvir S. Bhogal, Fort Worth, TX (US); Lisa Seacat DeLuca, San Francisco, CA (US); Robert R. Peterson, Austin, TX (US)

(73) Assignee: INTERNATIONAL BUSINESS MACHINES CORPORATION, Armonk, NY (US)

(21) Appl. No.: 13/588,805

(22) Filed: Aug. 17, 2012

(51) Int. Cl. H04M 3/487

(52) U.S. Cl. 379/218.01

(57) ABSTRACT

A set of call-specific metadata entries specified by a user that each represent a user-specified item of information to capture in association with a set of telephone numbers is obtained. The user-specified items of information represented by the set of call-specific metadata entries are captured from the user in association with a telephone number that is related to the set of call-specific metadata entries. The user-specified items of information are sorted based upon at least one user-specified item of information in response to detecting a user request to sort the captured user-specified items of information.

### BACKGROUND

The present invention relates to telephone calls and organization of information learned by a telephonic device user during telephone calls. More particularly, the present invention relates to telephone call set correlation and information ranking.

Users of telephonic devices, such as cellphones, smartphones, and land-line telephones, may place telephone calls to communicate with one another. As such, these telephonic devices provide a way for people to correspond by voice.

### BRIEF SUMMARY

A method includes obtaining, via a processor, a set of call-specific metadata entries specified by a user that each represent a user-specified item of information to capture in association with a set of telephone numbers; capturing, from the user in association with a telephone number that is related to the set of call-specific metadata entries, the user-specified items of information represented by the set of call-specific metadata entries; and sorting, in response to detecting a user request to sort the captured user-specified items of information based upon at least one user-specified item of information, the user-specified items of information.

A system includes a memory and a processor programmed to: obtain a set of call-specific metadata entries specified by a user that each represent a user-specified item of information to capture in association with a set of telephone numbers; capture, from the user in association with a telephone number that is related to the set of call-specific metadata entries, the user-specified items of information represented by the set of call-specific metadata entries within the memory; and sort, in response to detecting a user request to sort the captured user-specified items of information based upon at least one user-specified item of information, the user-specified items of information.

A computer program product includes a computer readable storage medium having computer readable program code embodied therewith, where the computer readable program code when executed on a computer causes the computer to obtain a set of call-specific metadata entries specified by a user that each represent a user-specified item of information to capture in association with a set of telephone numbers; capture, from the user in association with a telephone number that is related to the set of call-specific metadata entries, the user-specified items of information represented by the set of call-specific metadata entries; and sort in response to detecting a user request to sort the captured user-specified items of information based upon at least one user-specified item of information, the user-specified items of information.

### BRIEF DESCRIPTION OF THE SEVERAL VIEWS OF THE DRAWINGS

Figure (FIG.) 1 is a block diagram of an example of an implementation of a system for telephone call set correlation and information ranking according to an embodiment of the present subject matter;

Figure (FIG.) 2 is a block diagram of an example of an implementation of a core processing module capable of performing telephone call set correlation and information ranking according to an embodiment of the present subject matter;

Figure (FIG.) 3 is an illustration of an example of an implementation of a structured note as initially captured in response to a set of related calls within a memory storage location for telephone call set correlation and information ranking according to an embodiment of the present subject matter;

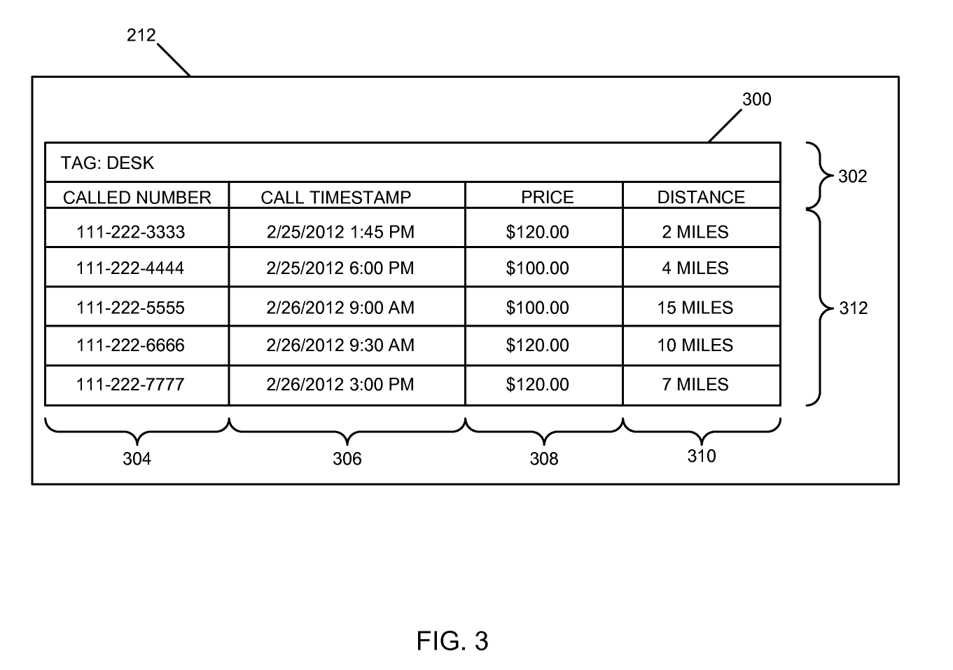

Figure (FIG.) 4 is an illustration of an example of an implementation of the structured note of FIG. 3 after sorting within a memory storage location for telephone call set correlation and information ranking according to an embodiment of the present subject matter;

Figure (FIG.) 5 is a flow chart of an example of an implementation of a process for telephone call set correlation and information ranking according to an embodiment of the present subject matter; and

Figure (FIG.) 6 is a flow chart of an example of an implementation of a process for telephone call set correlation and information ranking according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides telephone call set correlation and information ranking. The present technology allows a user of a telephonic or other communication device, such as a cellphone, smartphone, or land-line telephone, to record or associate metadata with individual information exchanges (e.g., telephone calls, emails, etc.) and to create subgroups/sets of telephone numbers, whether sequential or non-sequential information exchanges, that are grouped based upon the purpose of the information exchange and information learned during the information exchanges. For example, a user may make several telephone calls over time in an attempt to find a lowest price on an item the user desires to purchase and/or a shortest travel distance by which to acquire the item. The user may associate metadata with each such call and for each criterion of interest for the item (e.g., price, travel distance, salesperson's name, etc.) within the telephonic device to document the information learned during each call. After the user has completed all of the calls in the series, or at any intermediate time, the user may view the calls ranked by the metadata the user has entered. The user may further sort the created subgroup of calls based on one or more of the metadata criteria (e.g., lowest price, shortest travel distance, lowest prices at the shortest travel distance). As such, the user may document information learned during calls, emails, or other information exchanges and analyze that information without concerns for manual note taking or loss of paper notes. It should be understood that the terms “call” and “telephone call” are used for ease of description purposes within certain of the examples herein, though it is also understood that the present subject matter applies to any form of information exchanges where a user may learn information regardless of the communication manner. It is further understood that users may associate metadata with different forms of communication in combination (e.g., emails with telephone call, etc.) without departure from the scope of the present subject matter.

The metadata may be associated with telephone numbers by creation of a call set correlation data structure within a memory that stores information for telephone numbers in a call set/subgroup. The call set correlation data structure may include a set of call-specific metadata entries that represent data to be entered for each telephone number in a correlated set of sequential or non-sequential information exchanges. The call set correlation data structure may be referred to alternatively as a “structured note” herein for brevity.

The user may enter/select a tag/name that identifies a call set or subgroup and that the call is to be part of a series (again whether a sequential call or a non-sequential call) and may enter one or more numeric values, such as price, distance, and other values. The structured note may be formatted as appropriate for each particular call set, and as such, provide a call set-specific format for each call subgroup.

A telephonic device user may create/initiate a structured note to document information exchange set information in a variety of manners. For example, the user may utilize a keypad or touch-screen interface of the telephonic device and a menuing system of the user interface for the telephonic device to navigate to set of options for initiation of structured note creation for a call set. Similarly, a user of an email device may utilize a keypad or touchscreen interface of the email device and a menuing system of the user interface for the email device to navigate to a set of options for initiation of structured note creation for an email set. Again, different types of information exchanges may be combined within the same structured note. As such, the term “call set” is used herein for ease of description purposes.

Additionally, as another example, the telephonic device or email device may be configured with voice recognition technology to facilitate voice command structured note creation and data capture of desired data fields for structured notes. For example, voice commands such as “create call note” may be utilized to initiate creation of a structured note for a set of calls that are to be correlated using a telephonic device. Additional commands, such as “create data column” followed by a data column name (e.g., “Called Number,” “Call Timestamp,” “Sales Contact” “Price,” “Distance,” etc.) or other commands as appropriate for a given implementation, may be utilized to create data fields of interest to the user with respect to the particular structured note being created. In response to entry of such commands, a structured note may be created with the respective data columns, as described in more detail below.

Structured notes may be named utilizing any convenient identifier/tag, such as a product name that is to be researched (e.g., “Desk,” “Software,” etc.), or a service name (e.g., “Plumbing,” “Electrical,” etc.) that is to be researched, or otherwise as appropriate for a given implementation. Again, text entry or voice-recognition technology may be utilized to name structured notes. Existing structured notes may be selected after creation during multiple telephone calls, and data entries for the calls may be added to the structured notes.

Additionally, individual structured notes may be updated/populated in real time during telephone calls, during email exchanges, and during other information exchanges as appropriate for the given implementation. For example, device data determinations may be performed to populate a called telephone number data field within a structured note utilizing the dialed number as captured by the telephonic device. Additionally, a user may utilize text entry via a keypad or touch-screen interface to capture additional data field values for the structured note. As such, as a telephone call is in progress, the called telephone number may be captured by the telephonic device and the user may enter data (e.g., price, location/distance, etc.) to populate data fields within the structured note for the call set. As described above, user data entry may be performed utilizing a keypad or touch-screen interface, or by utilizing voice-recognition data entry technology, as appropriate for a given implementation. Further, a selection of input device may be configurable to select voice-recognition command input technology during times when the user is driving and to allow keypad or touch-screen interface during times when the user may more easily interact in a tactile manner with the telephonic device.

To provide an example, where a structured note has been created as described above with a tag name of “Desk” and with data fields for “Called Number,” “Call Timestamp,” “Price,” and “Distance,” whether by text input or voice-recognition technology, the called telephone number and call timestamp may be captured as the user dials a telephone number or otherwise initiates a telephone call to a telephone number. During the telephone call, the user may ask a salesperson if they carry a particular item of interest to the user, in this example a particular type of desk. The user may identify and recall (or create) a particular structured note in response to the salesperson indicating that the salesperson's store carries the product of interest to the user, again by text selection or voice-recognition technology. The telephonic device may parse the data field headings (e.g., column headings) of the structured note to determine the data fields within the particular structured note. The telephonic device may then populate the called number data field with the captured called telephone number and may prompt the user for information for the first data field of the structured note (e.g, price). The user may ask the salesperson for the price of the item of interest. The user may input the obtained price or the user may utilize a voice command to enter the price. It should be noted that the user may enter the respective data fields either during the telephone call or after the telephone call. The telephonic device may populate the price data field for the current call within the structured note with the price information that is input by the user. The telephonic device may prompt the user for information for the second data field of the structured note (e.g, distance). The user may then ask the salesperson for the location of their store and indicate that they are trying to determine a distance from the user's current location to the salesperson's store. The user may input the obtained distance information or the user may utilize a voice command to enter the distance. Again, the user may enter the respective data fields either during the telephone call or after the telephone call. The telephonic device may populate the distance data field for the current call within the structured note with the distance or location information that is input by the user. As such, the present technology may be utilized in real time during telephone calls to capture specific researched information and details associated with the structured note and the call set.

Continuing with the present example, the user may continue to place additional telephone calls to different stores/suppliers during the same telephone call session and the structured note may be updated according to information obtained during the additional telephone calls. Alternatively, the user may place telephone calls associated with an item of interest to the user for which data is to be captured within a structured note over a period of hours, days, or weeks. Because the structured notes may be identified and recalled based upon the particular item or service of interest to the user, structured notes may be populated with data as telephone calls associated with structured notes are placed by the user. As such, telephone calls may be identified and correlated within structured notes over time into call sets based upon the subject matter of the call without requiring the user to place a particular set of calls in a sequence. Accordingly, users may receive or place other unrelated telephone calls as structured notes are created and call sets may be identified/correlated and the information associated with the telephone calls within a set may be ranked at the convenience of the user.

Structured notes may further be categorized, sorted, and reviewed/updated by the user. As such, similar products or services may be researched within different structured notes. The structured notes may be combined, compared, or otherwise analyzed as desired by the user. Further, voice recognition for user-spoken commands may be utilized for categorizing, sorting, and reviewing/updating structured notes. For example, a user may speak commands such as “sort by price,” “read results,” “call second result,” and other spoken commands as appropriate for a given use and implementation. As such, users may utilize captured information without looking at the resulting table on a display of the telephonic device. Additionally, a user may evaluate data obtained during related/correlated information exchanges, such as conversations, emails, or other forms of information exchange. The user may then compare aspects of those information exchanges quickly, either visually or using voice response processing.

The present technology may further assist users within a social setting. For example, one telephonic device user may choose to share information/findings with contacts/friends within their social network circle. As such, rather than each telephonic device user having to make multiple phone calls themselves to find the best price or location for purchase of a particular item, the users that perform the initial research may share the call set information (e.g., structured note) with their contacts/friends. As such, another user that is interested in the same item/product, may see that another contact/friend already researched the item and may therefore use the other user's findings.

As such, a structured note may be stored within a telephonic device or elsewhere within a network, such as in association with a social networking server. User and contacts/friends of users may collaborate to perform research associated with products and/or services or otherwise as appropriate for a given implementation.

The saved tag groups may be updated over time. For example, if a user learns at a later time that the price of a particular item for which the tag group has been created has increased or decreased, that user may update the price tag. Further, if a new location at which to purchase the item associated with a structured note is identified, the user may add the new location and price information to the structured note. Additionally, the user may update the ranking table and re-share the structured note with the modified price/location information and with the new ranking(s).

Any contact/friend that is interested in a particular item may configure a request for notification of updates to structured notes. In response to an update to a structured note for which a notification has been configured, an alert may be generated and sent to the user's telephonic device. The notification may be presented on the user's telephonic device to indicate that a new lower price or location was entered, and the user may view the new information and/or ranking(s).

It should be noted that conception of the present subject matter resulted from recognition of certain limitations associated with organization of information learned by callers during telephone calls. For example, it was observed that a telephonic device user may place several telephone calls during a search among a group of suppliers (e.g., retailers, wholesalers, etc.) for a best price on an item the user desires to purchase and/or a closest location at which to purchase the item to allow the shortest travel distance. It was further observed that the user has to write down the information learned during the set of telephone calls to document the information learned. However, it was further observed that if, for example, a user is attempting to place calls to find a reasonably priced hotel while driving from an airport in a new town, writing down the information learned during a set of telephone calls may be dangerous for the user and for others on the roadways. In view of this observation, it was determined that it was desirable to provide technology to assist such a user and to reduce the actions required of the user while driving to allow the user to more safely document the information learned during a set of calls. It was additionally observed that the set of telephone calls may be interleaved with other calls/activities and may span extended lengths of time (e.g., hours, days, or weeks). In view of this observation, it was determined that keeping track of the information learned during a set of telephone calls under such circumstances is difficult for a telephonic device user. It was further determined that there has been no existing available solution to correlate and/or rank the information learned during such a set of telephone calls to allow the user to make a decision with respect to the purchase based upon a variety of data points (e.g., price, location, etc.). The present subject matter improves call set correlation by providing for telephone call set correlation and information ranking, as described above and in more detail below. As such, improved telephone call set correlation and information ranking may be obtained by use of the present technology.

The telephone call set correlation and information ranking described herein may be performed in real time to allow prompt correlation of information learned by a user during a set of sequential or non-sequential telephone calls. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

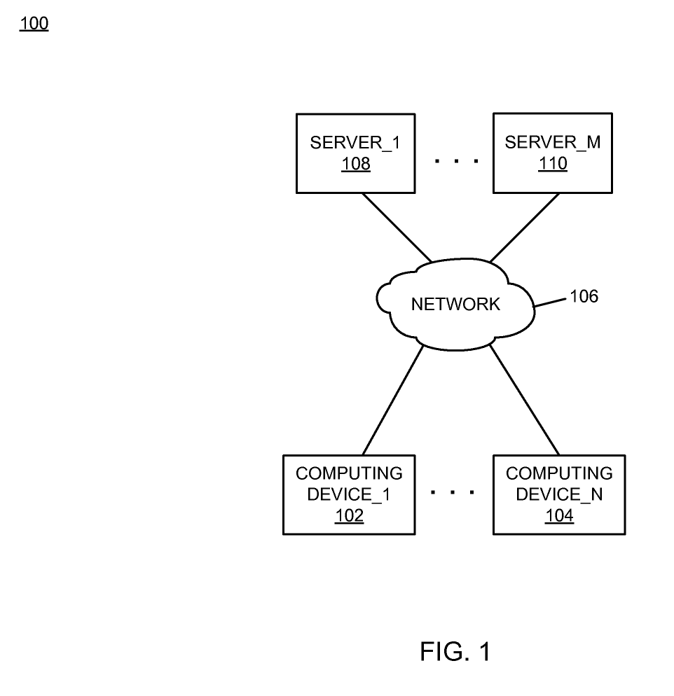

FIG. 1 is a block diagram of an example of an implementation of a system 100 for telephone call set correlation and information ranking. A computing device_1 102 through a computing device_N 104 communicate via a network 106 with several other devices. The other devices include a server_1 108 through a server_M 110.

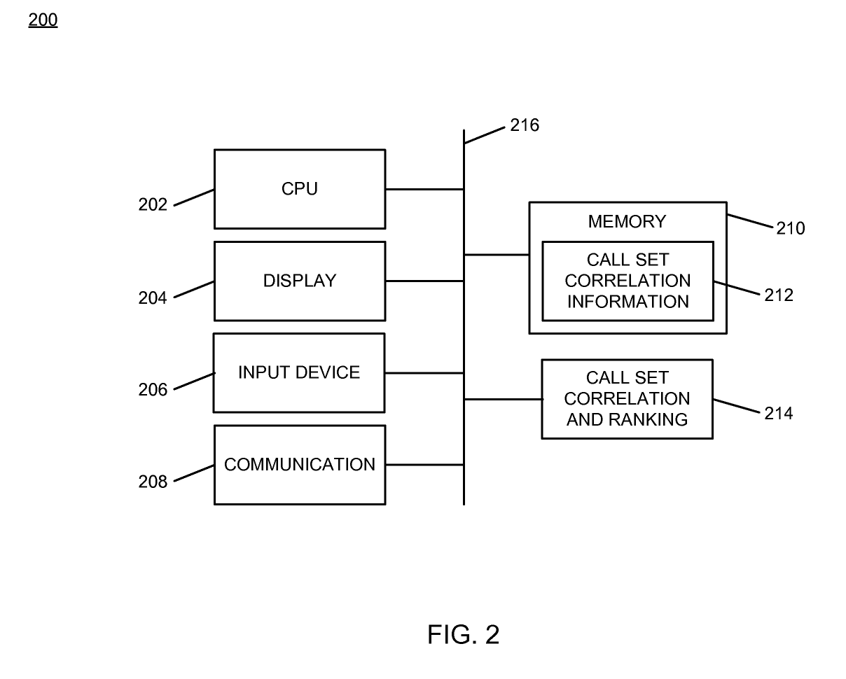

As will be described in more detail below in association with FIG. 2 through FIG. 6, the computing device_1 102 through the computing device_N 104 provide automated telephone call set correlation and information ranking. The automated telephone call set correlation and information ranking is based upon call set identification and correlation from a variety of telephone calls that may be unrelated. Structured notes may be created and populated for call sets and information within structured notes may be ranked and sorted. Structured notes may be shared and updated by contacts/friends, and notifications may be provided to the structured note creator and to other contacts/friends as additional research associated with a particular structured note is performed and information is added to or updated within a structured note. As such, a variety of possibilities exist for implementation of the present subject matter, and all such possibilities are considered within the scope of the present subject matter.

It should be noted that the computing device_1 102 through the computing device_N 104 may be portable computing devices, either by a user's ability to move the respective devices to different locations, or by the devices' association with a portable platform, such as a plane, train, automobile, or other moving vehicle. It should also be noted that the computing device_1 102 through the computing device_N 104 may be any computing device capable of processing information as described above and in more detail below. For example, the computing device_1 102 through the computing device_N 104 may include any devices that include the capability of placing a telephone call, such as a personal computer (e.g., desktop, laptop, etc.) or a handheld device (e.g., cellular telephone, smartphone, personal digital assistant (PDA), etc.), or any other device capable of processing information as described above and in more detail below.

The network 106 may include any form of interconnection suitable for the intended purpose, including a private or public network such as an intranet or the Internet, respectively, direct inter-module interconnection, dial-up, wireless, or any other interconnection mechanism capable of interconnecting the respective devices.

The server_1 108 through a server_M 110 may include any device capable of providing data for consumption by a device, such as the computing device_1 102 through the computing device_N 104, via a network, such as the network 106. As such, the server_1 108 through a server_M 110 may each include a web server, application server, social networking server, or other data server device.

FIG. 2 is a block diagram of an example of an implementation of a core processing module 200 capable of performing telephone call set correlation and information ranking. The core processing module 200 may be associated with either the computing device_1 102 through the computing device_N 104 or with the server_1 108 through the server_M 110, as appropriate for a given implementation. As such, the core processing module 200 is described generally herein, though it is understood that many variations on implementation of the components within the core processing module 200 are possible and all such variations are within the scope of the present subject matter.

Further, the core processing module 200 may provide different and complementary processing of telephone call set correlation and information ranking in association with each implementation. As such, for any of the examples below, it is understood that any aspect of functionality described with respect to any one device that is described in conjunction with another device (e.g., sends/sending, etc.) is to be understood to concurrently describe the functionality of the other respective device (e.g., receives/receiving, etc.).

A central processing unit (CPU) 202 provides computer instruction execution, computation, and other capabilities within the core processing module 200. A display 204 provides visual information to a user of the core processing module 200 and an input device 206 provides input capabilities for the user.

The display 204 may include any display device, such as a cathode ray tube (CRT), liquid crystal display (LCD), light emitting diode (LED), electronic ink displays, projection, touchscreen, or other display element or panel. The input device 206 may include a computer keyboard, a keypad, a mouse, a pen, a joystick, touchscreen, or any other type of input device by which the user may interact with and respond to information on the display 204.

It should be noted that the display 204 and the input device 206 may be optional components for the core processing module 200 for certain implementations/devices (e.g., at a server device such as one or more of the server_1 108 through the server_M 110). Accordingly, the core processing module 200 may operate as a completely automated embedded device without direct user configurability or feedback. However, the core processing module 200 may also provide user feedback and configurability via the display 204 and the input device 206, respectively, as appropriate for a given implementation.

A communication module 208 provides interconnection capabilities that allow the core processing module 200 to communicate with other modules within the system 100. The communication module 208 may include any electrical, protocol, and protocol conversion capabilities useable to provide interconnection capabilities, appropriate for a given implementation.

A memory 210 includes a call set correlation information storage area 212 that stores call set information, such as structured notes, ranking information, and other information associated with call sets within the core processing module 200. As will be described in more detail below, call set correlation information stored within the call set correlation information storage area 212 is used to provide real-time research result entry, ranking, sorting, and other processing associated with structured notes and call set correlation.

It is understood that the memory 210 may include any combination of volatile and non-volatile memory suitable for the intended purpose, distributed or localized as appropriate, and may include other memory segments not illustrated within the present example for ease of illustration purposes. For example, the memory 210 may include a code storage area, an operating system storage area, a code execution area, and a data area without departure from the scope of the present subject matter.

A call set correlation and ranking module 214 is also illustrated. The call set correlation and ranking module 214 provides processing capabilities associated with call sets for the core processing module 200, as described above and in more detail below. The call set correlation and ranking module 214 implements the automated telephone call set correlation and information ranking of the core processing module 200. The call set correlation and ranking module 214 may further utilize communications technology to perform map query and search processing to determine relative distances to product/service provider locations, such as by use of one or more of the server_1 108 through the server_M 110.

It should also be noted that the call set correlation and ranking module 214 may form a portion of other circuitry described without departure from the scope of the present subject matter. Further, the call set correlation and ranking module 214 may alternatively be implemented as an application stored within the memory 210. In such an implementation, the call set correlation and ranking module 214 may include instructions executed by the CPU 202 for performing the functionality described herein. The CPU 202 may execute these instructions to provide the processing capabilities described above and in more detail below for the core processing module 200. The call set correlation and ranking module 214 may form a portion of an interrupt service routine (ISR), a portion of an operating system, a portion of a browser application, or a portion of a separate application without departure from the scope of the present subject matter.

The CPU 202, the display 204, the input device 206, the communication module 208, the memory 210, and the call set correlation and ranking module 214 are interconnected via an interconnection 216. The interconnection 216 may include a system bus, a network, or any other interconnection capable of providing the respective components with suitable interconnection for the respective purpose.

Though the different modules illustrated within FIG. 2 are illustrated as component-level modules for ease of illustration and description purposes, it should be noted that these modules may include any hardware, programmed processor(s), and memory used to carry out the functions of the respective modules as described above and in more detail below. For example, the modules may include additional controller circuitry in the form of application specific integrated circuits (ASICs), processors, antennas, and/or discrete integrated circuits and components for performing communication and electrical control activities associated with the respective modules. Additionally, the modules may include interrupt-level, stack-level, and application-level modules as appropriate. Furthermore, the modules may include any memory components used for storage, execution, and data processing for performing processing activities associated with the respective modules. The modules may also form a portion of other circuitry described or may be combined without departure from the scope of the present subject matter.

Additionally, while the core processing module 200 is illustrated with and has certain components described, other modules and components may be associated with the core processing module 200 without departure from the scope of the present subject matter. Additionally, it should be noted that, while the core processing module 200 is described as a single device for ease of illustration purposes, the components within the core processing module 200 may be co-located or distributed and interconnected via a network without departure from the scope of the present subject matter. For a distributed arrangement, the display 204 and the input device 206 may be located at a point of sale device, kiosk, or other location, while the CPU 202 and memory 210 may be located at a local or remote server. Many other possible arrangements for components of the core processing module 200 are possible and all are considered within the scope of the present subject matter. Accordingly, the core processing module 200 may take many forms and may be associated with many platforms.

FIG. 3 is an illustration of an example of an implementation of a structured note 300 as initially captured in response to a set of related calls within a memory storage location, such as the call set correlation information storage area 212 of the memory 210, for telephone call set correlation and information ranking. The structured note 300 includes a header section 302 that includes a tag/identifier of the structured note 300, that is within the present example titled “DESK,” that provides context for use of the structured note 300. The header section 302 also includes column headings for dated captured during telephone calls that are related to the subject matter of the structured note 300. For purposes of example, a “CALLED NUMBER” column 304, a “CALL TIMESTAMP” column 306, a “PRICE” column 308, and a “DISTANCE” column 310 are illustrated. A set of rows 312 each store information for a call associated with the call set represented within the structured note 300. Each of the rows 312 includes data entries that were captured during one telephone call, as described above.

It should be noted that the rows 312 within the structured note 300 include timestamps within the CALL TIMESTAMP column 306 that represent both different times and different dates during which respective calls were placed and the respective information was captured. As such and as described above, the telephone call set correlation and information ranking described herein may be utilized to capture information associated with related calls that are not sequential calls. It is further understood that a structured note, such as the structured note 300 may be formatted with any data of interest to the user of the present technology. Additionally, while the structured note 300 is illustrated to capture data in columnar form, other formatting may be utilized as appropriate for a given implementation.

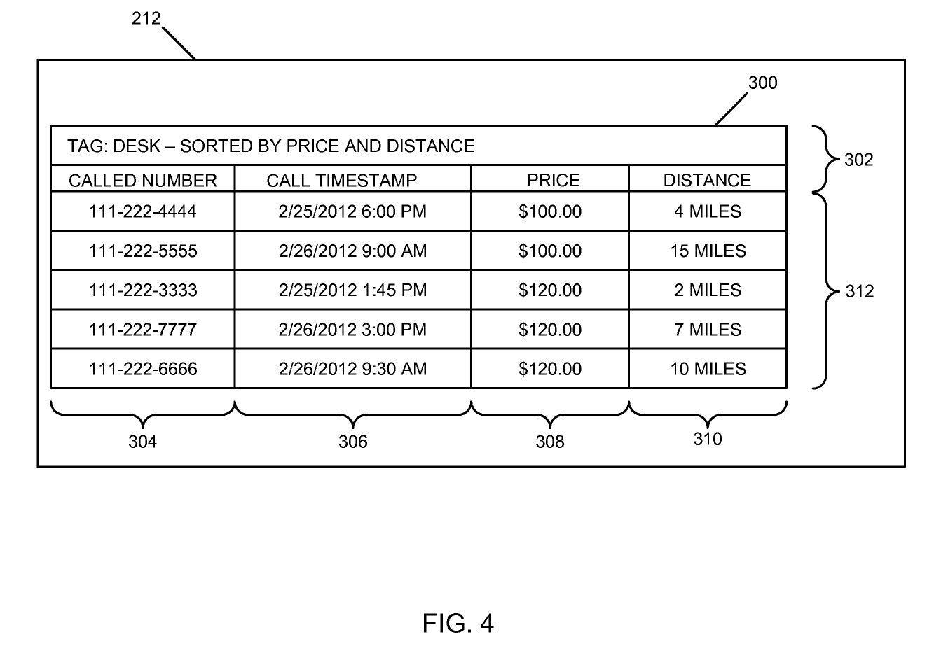

FIG. 4 is an illustration of an example of an implementation of the structured note 300 of FIG. 3 after sorting within a memory storage location, such as the call set correlation information storage area 212 of the memory 210, for telephone call set correlation and information ranking. For purposes of the present example, it is assumed that a user request has been detected to sort the entries/rows 312 within the structured note 300 based upon both price and distance, though other sorting may be implemented as appropriate for a given implementation.

As can be seen from FIG. 4, the rows 312 have been reordered in response to a detected command to sort the structured note 300 based on price and distance. For purposes of example, the tag/identifier within the header 302 has been updated to indicate the structured note 300 has been sorted by price and distance. Further, the rows 312 now show that the lowest-priced item that may be purchased at the closest distance to the user is the first entry within the rows 312. Many other possibilities associated with structured note creation, and call set correlation and processing are possible and all are considered within the scope of the present subject matter.

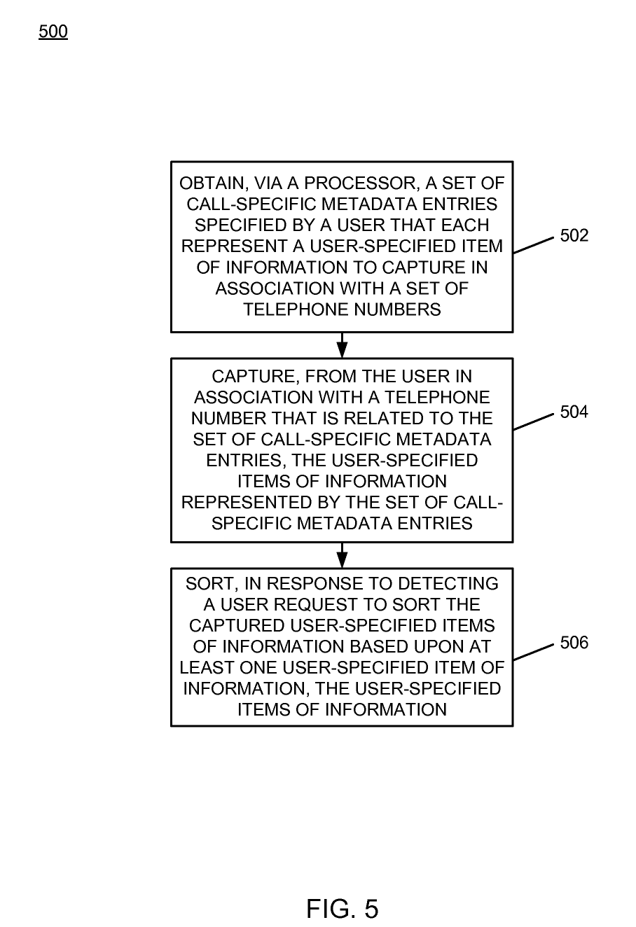

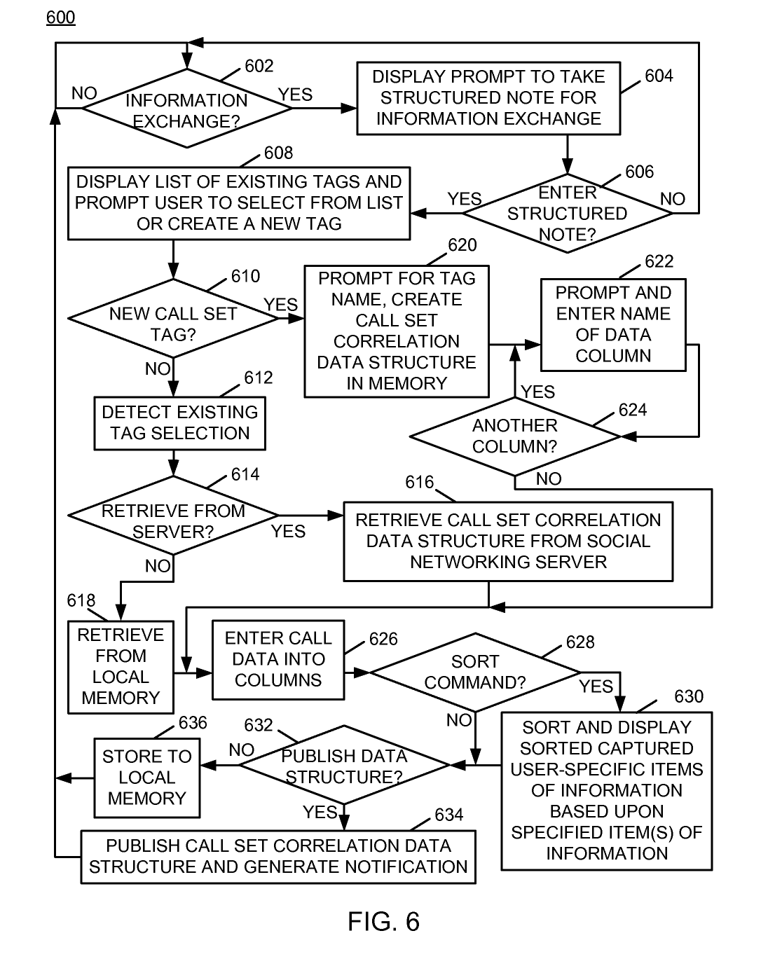

FIG. 5 through FIG. 6 described below represent example processes that may be executed by devices, such as the core processing module 200, to perform the telephone call set correlation and information ranking associated with the present subject matter. Many other variations on the example processes are possible and all are considered within the scope of the present subject matter. The example processes may be performed by modules, such as the call set correlation and ranking module 214 and/or executed by the CPU 202, associated with such devices. It should be noted that time out procedures and other error control procedures are not illustrated within the example processes described below for ease of illustration purposes. However, it is understood that all such procedures are considered to be within the scope of the present subject matter. Further, the described processes may be combined, sequences of the processing described may be changed, and additional processing may be added or removed without departure from the scope of the present subject matter.

FIG. 5 is a flow chart of an example of an implementation of a process 500 for telephone call set correlation and information ranking. At block 502, the process 500 obtains, via a processor, a set of call-specific metadata entries specified by a user that each represent a user-specified item of information to capture in association with a set of telephone numbers. At block 504, the process 500 captures, from the user in association with a telephone number that is related to the set of call-specific metadata entries, the user-specified items of information represented by the set of call-specific metadata entries. At block 506, the process 500 sorts, in response to detecting a user request to sort the captured user-specified items of information based upon at least one user-specified item of information, the user-specified items of information.

FIG. 6 is a flow chart of an example of an implementation of a process 600 for telephone call set correlation and information ranking. It should be noted that the following example utilizes a telephone call and related processing for telephone call set correlation and information ranking at certain stages for ease of description purposes. However, other information exchanges may be utilized or combined as appropriate for a given implementation, such as emails or other information exchanges. At decision point 602, the process 600 makes determination as to whether an information exchange, such as a telephone call, email information exchange, or other information exchange has been detected as being initiated by a user. In response to determining that an information exchange has been detected, the process 600 displays a prompt to offer the user the opportunity to take a structured note for the information exchange at block 604. As described above, the term “structured note” refers to a call set correlation data structure stored within a memory that includes a set of call-specific metadata entries. Additionally, as described above, a set of telephone numbers associated with sequential or non-sequential information exchanges (e.g., telephone calls) may be correlated as related to information obtained during the information exchanges and the set of telephone numbers associated with the sequential or non-sequential information exchanges may be represented in the structured note to provide correlation and sorting capabilities for the obtained information.

At decision point 606, the process 600 makes a determination as to whether the user has responded to the prompt affirmatively to enter a structured note for the information exchange or whether the user has declined the opportunity to take the structured note for the information exchange. In response to determining that the user has declined the opportunity to take the structured note for the information exchange, the process 600 returns to decision point 602 and iterates as described above. As such, the process 600 allows the user to selectively enter structured notes for telephone numbers associated with sequential or non-sequential telephone calls, or other information exchanges, and may identify multiple non-sequential telephone calls placed by, or other information exchanges performed by, the user as related to the set of call-specific metadata entries within a call set correlation data structure. Accordingly, the process 600 may correlate at least two telephone numbers associated with non-sequential telephone calls or other information exchanges within a call set correlation data structure in response to identifying at least two non-sequential telephone calls or other information exchanges as related to a particular set of call-specific metadata entries.

Returning to the description of decision point 606, in response to determining that the user has responded to the prompt affirmatively to enter a structured note for the information exchange, the process 600 displays a list of existing tags that identify existing correlated call sets and prompts the user to select from the list or to create a new tag (e.g., a new call set (e.g., telephone number set) correlation data structure to initiate a new correlated call set) at block 608. It should be noted that existing call set correlation data structures may be stored locally. Additionally or alternatively, existing call set correlation data structures may be stored at a server, such as a social networking server, to allow users to share information obtained during correlated call sets (e.g., correlated telephone number sets). As such, the existing tags within the list may represent locally-stored call set correlation data structures or remotely-stored call set correlation data structures. Further, an existing call set correlation data structure may be retrieved from such a server in response to a first user selection.

At decision point 610, the process 600 makes a determination as to whether the user has selected/chosen to create a new call set tag and a new call set correlation data structure, or whether the user has selected/chosen to utilize an existing call set correlation data structure. In response to determining that the user has chosen not to create a new call set tag and a new call set correlation data structure, and to instead select an existing tag and an existing call set correlation data structure, the process 600 detects an existing tag selection at block 612.

At decision point 614, the process 600 makes determination as to whether to retrieve the existing call set correlation data structure from a social networking server or from local storage. The determination as to whether to retrieve existing call set correlation data structure from a social networking server may be performed in response to receiving a notification from the social networking server that the selected call set correlation data structure stored at the social networking server that includes data associated with the set of call-specific metadata entries has been updated by another social networking server user. Additionally, the determination as to whether to retrieve existing call set correlation data structure from social networking server may be performed in response to receiving a notification from the social networking server that the existing call set correlation data structure associated with the selected existing tag is stored at the social networking server.

In response to determining to retrieve the existing call set correlation data structure from the social networking server, the process 600 retrieves an existing call set correlation data structure that is not already stored locally or an updated call set correlation data structure from the social networking server at block 616. Alternatively, in response to determining to retrieve the existing call set correlation data structure from local memory, the process 600 retrieves the selected call set correlation data structure from the local memory at block 618. Additional processing within this branch of the process 600 will be deferred and described in more detail below to describe call set correlation data structure creation.

Returning to the description of decision point 610, in response to determining that the user is chosen to create a new call set tag and a new call set correlation data structure, the process 600 prompts the user for the new tag name and creates the call set correlation data structure in the memory at block 620. At block 622, the process 600 prompts the user for a name of a data column and a value for the data column and enters the name of the data column and value into the call set correlation data structure. At decision point 624, the process 600 makes a determination as to whether the user has requested to create another data column. In response to determining that the user has requested to create another data column, the process 600 returns to block 622 and iterates as described above until all data columns of the newly created call set correlation data structure have been populated.

In response to determining that the user has completed data column creation at decision point 624, or in response to retrieving an existing call set correlation data structure either from a social networking server at block 616 or from a local memory at block 618, the process 600 facilitates/allows user entry of call data into the data columns of the call set correlation data structure at block 626. It should be noted that the information obtained during the call, email, or other information exchange may be entered into the call set correlation data structure either during or after the telephone call, email, or other information exchange.

As such, the process 600 provides a user interface (UI) of a telephone call set correlation application for associating a set of call-specific metadata entries with the set of telephone calls or telephone numbers. In response to the user utilizing the UI for a telephone call, the process 600 provides a set of options for associating the set of call-specific metadata entries with the information exchange including displaying a list of tags to associate the telephone call, email, or other information exchange with the set of telephone numbers and allowing identification of a new tag in the list of tags. In response to the user identifying the new tag for the information exchange, the process 600 creates a call set correlation data structure labeled with the new tag and creates a new entry to store the set of call-specific metadata entries for the information exchange within the call set correlation data structure. Additionally, the process 600 allows labels for each item of the set of call-specific metadata entries to be defined by the user during or after the information exchange. The process 600 also allows data for the set of call-specific metadata entries to be entered by the user during or after the information exchange. Further, the process 600 may update a call set correlation data structure in response to capturing user-specified items of information represented by the set of call-specific metadata entries for the telephone call placed by, or the other information exchange performed by, the user.

At decision point 628, the process 600 makes a determination as to whether a sort command has been detected from the user. As described above, the user may utilize text entry or voice commands to initiate a sort command to cause the process 600 to sort data within a call set correlation data structure. Further, a sort command may include a request to sort the captured user-specified items of information within the call set correlation data structure based upon two or more user-specified items of information.

In response to determining that a sort command has been detected from the user at decision point 628, the process 600 sorts and displays the sorted captured user specific items of information based upon the specified items of information at block 630. It is understood that where multiple items of information are specified within a sort, the process 600 may perform a first-level sort of the captured user-specified items of information using a first user-specified item of information of the multiple user-specified items of information, and may then perform an additional multiple-level sort based upon the additional user-specified items of information. For example, and returning to an earlier example, the process 600 may sort the data captured during a correlated set of telephone numbers (associated with telephone calls, emails, or other information exchanges) based upon both price and distance, or other criteria as appropriate for a given implementation.

In response to completion of the sorting at block 630, or in response to determining that a sort command has not been detected from the user at decision point 628, the process 600 makes a determination at decision point 632 as to whether to publish the data structure, such as to a social networking server. In response to determining to publish the call set correlation data structure, the process 600 publishes the call set correlation data structure including the set of call-specific metadata entries (e.g., to a social networking server) and generates a notification (e.g., via the social networking server) at block 634. This notification may, for example, indicate that the set of call-specific metadata entries have been published to share with contacts via the social networking server. In response to determining at decision point 632 not to publish the call set correlation data structure, the process 600 stores the call set correlation data structure to a local memory at block 636. In response to either publishing the call set correlation data structure and generating the notification at block 634, or in response to storing the call set correlation data structure to a local memory of block 636, the process 600 returns to decision point 602 and iterates as described above.

As such, the process 600 obtains a set of call-specific metadata entries specified by a user that each represent a user-specified item of information to capture with a set of telephone numbers, from telephone calls, emails, or from other forms of information exchange. The process 600 also captures the user-specified items of information represented by the set of call-specific metadata entries from the user in association with a telephone number that is related to the set of call-specific metadata entries. The process 600 allows the user to create call set correlation data structures, allows the user to sort the captured user-specified items of information represented by the set of call-specific metadata entries within the call set correlation data structure, and allows the user to publish the captured information via, for example, a social networking server to share the research activities of the user with the user's contacts/friends.

As described above in association with FIG. 1 through FIG. 6, the example systems and processes provide telephone call set correlation and information ranking. Many other variations and additional activities associated with telephone call set correlation and information ranking are possible and all are considered within the scope of the present subject matter.

Those skilled in the art will recognize, upon consideration of the above teachings, that certain of the above examples are based upon use of a programmed processor, such as the CPU 202. However, the invention is not limited to such example embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as JAVA™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
obtaining, via a processor, a set of call-specific metadata entries specified by a user that each represent a user-specified item of information to capture in association with a set of telephone numbers;
capturing, from the user in association with a telephone number that is related to the set of call-specific metadata entries, the user-specified items of information represented by the set of call-specific metadata entries; and
sorting, in response to detecting a user request to sort the captured user-specified items of information based upon at least one user-specified item of information, the user-specified items of information.

2. The method of claim 1, where:
obtaining, via the processor, the set of call-specific metadata entries specified by the user that each represent the user-specified item of information to capture in association with the set of telephone numbers comprises:
retrieving a call set correlation data structure comprising the set of call-specific metadata entries from a social networking server; and
further comprising:
updating the call set correlation data structure with the user-specified items of information captured in association with the telephone number in response to capturing the user-specified items of information represented by the set of call-specific metadata entries for the telephone number; and
storing the updated call set correlation data structure to the social networking server.

3. The method of claim 1, where obtaining, via the processor, the set of call-specific metadata entries specified by the user that each represent the user-specified item of information to capture in association with the set of telephone numbers comprises:
receiving a notification that a call set correlation data structure stored at a social networking server that comprises data associated with the set of call-specific metadata entries has been updated by another social networking server user; and
retrieving the updated call set correlation data structure from the social networking server.

4. The method of claim 1, where obtaining, via the processor, the set of call-specific metadata entries specified by the user that each represent the user-specified item of information to capture in association with the set of telephone numbers comprises:
providing a user interface (UI) of a telephone call set correlation application for associating the set of call-specific metadata entries with the set of telephone numbers; and
providing, in response to the user utilizing the UI for the telephone number, a set of options for associating the set of call-specific metadata entries with the telephone number comprising:
displaying a list of tags to associate the telephone number with the set of telephone numbers and allowing identification of a new tag in the list of tags;
in response to the user identifying the new tag for the telephone number:
creating a call set correlation data structure labeled with the new tag; and
creating a new entry to store the set of call-specific metadata entries for the telephone number within the call set correlation data structure; and
allowing labels for each item of the set of call-specific metadata entries to be defined by the user during a telephone call and data for the set of call-specific metadata entries to be entered by the user in association with the telephone number.

5. The method of claim 1, further comprising:
publishing the set of call-specific metadata entries to a social networking server; and
generating a notification via the social networking server that indicates that the set of call-specific metadata entries have been published to share the set of call-specific metadata entries with contacts via the social networking server.

6. The method of claim 1, further comprising:
identifying at least two telephone numbers associated with non-sequential telephone calls placed by the user as related to the set of call-specific metadata entries; and
correlating the at least two telephone numbers associated with the non-sequential telephone calls within a call set correlation data structure in response to identifying the at least two telephone numbers associated with the non-sequential telephone calls as related to the set of call-specific metadata entries.

7. The method of claim 1, further comprising:
determining that the user request to sort the captured user-specified items of information based upon the at least one user-specified item of information comprises a user request to sort the captured user-specified items of information based upon at least two user-specified items of information; and
where sorting, in response to detecting the user request to sort the captured user-specified items of information based upon the at least one user-specified item of information, the user-specified items of information comprises:
performing a first-level sort of the captured user-specified items of information using a first user-specified item of information of the at least two user-specified items of information; and
performing an additional multiple-level sort based upon the additional at least two user-specified items of information.

8. A system, comprising:
a memory; and
a processor programmed to:
obtain a set of call-specific metadata entries specified by a user that each represent a user-specified item of information to capture in association with a set of telephone numbers;
capture, from the user in association with a telephone number that is related to the set of call-specific metadata entries, the user-specified items of information represented by the set of call-specific metadata entries within the memory; and
sort, in response to detecting a user request to sort the captured user-specified items of information based upon at least one user-specified item of information, the user-specified items of information.

9. The system of claim 8, where, in being programmed to:
obtain the set of call-specific metadata entries specified by the user that each represent the user-specified item of information to capture in association with the set of telephone numbers, the processor is programmed to:
retrieve a call set correlation data structure comprising the set of call-specific metadata entries from a social networking server; and
the processor is further programmed to:
update the call set correlation data structure with the user-specified items of information captured in association with the telephone number in response to capturing the user-specified items of information represented by the set of call-specific metadata entries for the telephone number; and
store the updated call set correlation data structure to the social networking server.

10. The system of claim 8, where, in being programmed to obtain the set of call-specific metadata entries specified by the user that each represent the user-specified item of information to capture in association with the set of telephone numbers, the processor is programmed to:
receive a notification that a call set correlation data structure stored at a social networking server that comprises data associated with the set of call-specific metadata entries has been updated by another social networking server user; and
retrieve the updated call set correlation data structure from the social networking server.

11. The system of claim 8, where, in being programmed to obtain the set of call-specific metadata entries specified by the user that each represent the user-specified item of information to capture in association with the set of telephone numbers, the processor is programmed to:
provide a user interface (UI) of a telephone call set correlation application for associating the set of call-specific metadata entries with the set of telephone numbers; and
provide, in response to the user utilizing the UI for the telephone number, a set of options for associating the set of call-specific metadata entries with the telephone number comprising:
displaying a list of tags to associate the telephone number with the set of telephone numbers and allowing identification of a new tag in the list of tags;
in response to the user identifying the new tag for the telephone number:
creating a call set correlation data structure labeled with the new tag; and
creating a new entry to store the set of call-specific metadata entries for the telephone number within the call set correlation data structure; and
allowing labels for each item of the set of call-specific metadata entries to be defined by the user during a telephone call and data for the set of call-specific metadata entries to be entered by the user in association with the first telephone number.

12. The system of claim 8, where the processor is further programmed to:
publish the set of call-specific metadata entries to a social networking server; and
generate a notification via the social networking server that indicates that the set of call-specific metadata entries have been published to share the set of call-specific metadata entries with contacts via the social networking server.

13. The system of claim 8, where the processor is further programmed to:
identify at least two telephone numbers associated with non-sequential telephone calls placed by the user as related to the set of call-specific metadata entries; and
correlate the at least two telephone numbers associated with the non-sequential telephone calls within a call set correlation data structure in response to identifying the at least two telephone numbers associated with the non-sequential telephone calls as related to the set of call-specific metadata entries.

14. A computer program product, comprising:
a computer readable storage medium having computer readable program code embodied therewith, where the computer readable program code when executed on a computer causes the computer to:
obtain a set of call-specific metadata entries specified by a user that each represent a user-specified item of information to capture in association with a set of telephone numbers;
capture, from the user in association with a telephone number that is related to the set of call-specific metadata entries, the user-specified items of information represented by the set of call-specific metadata entries; and
sort in response to detecting a user request to sort the captured user-specified items of information based upon at least one user-specified item of information, the user-specified items of information.

15. The computer program product of claim 14, where in causing the computer to:
obtain the set of call-specific metadata entries specified by the user that each represent the user-specified item of information to capture in association with the set of telephone numbers, the computer readable program code when executed on the computer causes the computer to:
retrieve a call set correlation data structure comprising the set of call-specific metadata entries from a social networking server; and
the computer readable program code when executed on the computer further causes the computer to:
update the call set correlation data structure with the user-specified items of information captured in association with the telephone number in response to capturing the user-specified items of information represented by the set of call-specific metadata entries for the telephone number; and
store the updated call set correlation data structure to the social networking server.

16. The computer program product of claim 14, where in causing the computer to obtain the set of call-specific metadata entries specified by the user that each represent the user-specified item of information to capture in association with the set of telephone numbers, the computer readable program code when executed on the computer causes the computer to:
receive a notification that a call set correlation data structure stored at a social networking server that comprises data associated with the set of call-specific metadata entries has been updated by another social networking server user; and
retrieve the updated call set correlation data structure from the social networking server.

17. The computer program product of claim 14, where in causing the computer to obtain the set of call-specific metadata entries specified by the user that each represent the user-specified item of information to capture in association with the set of telephone numbers, the computer readable program code when executed on the computer causes the computer to:
provide a user interface (UI) of a telephone call set correlation application for associating the set of call-specific metadata entries with the set of telephone numbers; and
provide, in response to the user utilizing the UI for the telephone number, a set of options for associating the set of call-specific metadata entries with the telephone number comprising:
displaying a list of tags to associate the telephone number with the set of telephone numbers and allowing identification of a new tag in the list of tags;
in response to the user identifying the new tag for the telephone number:
creating a call set correlation data structure labeled with the new tag; and
creating a new entry to store the set of call-specific metadata entries for the telephone number within the call set correlation data structure; and
allowing labels for each item of the set of call-specific metadata entries to be defined by the user during a telephone call and data for the set of call-specific metadata entries to be entered by the user in association with the telephone number.

18. The computer program product of claim 14, where the computer readable program code when executed on the computer further causes the computer to:
publish the set of call-specific metadata entries to a social networking server; and
generate a notification via the social networking server that indicates that the set of call-specific metadata entries have been published to share the set of call-specific metadata entries with contacts via the social networking server.

19. The computer program product of claim 14, where the computer readable program code when executed on the computer further causes the computer to:
identify at least two telephone numbers associated with non-sequential telephone calls placed by the user as related to the set of call-specific metadata entries; and
correlate the at least two telephone numbers associated with the non-sequential telephone calls within a call set correlation data structure in response to identifying the at least two telephone numbers associated with the non-sequential telephone calls as related to the set of call-specific metadata entries.

20. The computer program product of claim 14, where the computer readable program code when executed on the computer further causes the computer to:
determine that the user request to sort the captured user-specified items of information based upon the at least one user-specified item of information comprises a user request to sort the captured user-specified items of information based upon at least two user-specified items of information; and
where, in causing the computer to sort, in response to detecting the user request to sort the captured user-specified items of information based upon the at least one user-specified item of information, the user-specified items of information, the computer readable program code when executed on the computer causes the computer to:
perform a first-level sort of the captured user-specified items of information using a first user-specified item of information of the at least two user-specified items of information; and
perform an additional multiple-level sort based upon the additional at least two user-specified items of information.
